(19) United States
(12) Patent Application Publication
(10) Pub. No.: US 2024/0365801 A1
(43) Pub. Date: Nov. 7, 2024

(54) IRRADIATION OF GRAIN OR SEEDS

(71) Applicant: ANIMAL CONTROL TECHNOLOGIES (AUSTRALIA) PTY LTD, Somerton, Victoria (AU)

(72) Inventor: Linton Drew STAPLES, Somerton, Victoria (AU)

(21) Appl. No.: 18/572,622

(22) PCT Filed: Jul. 22, 2022
(86) PCT No.: PCT/AU2022/050780

§ 371 Date: Dec. 20, 2023

(30) Foreign Application Priority Data
Jul. 23, 2021 (AU) 2021902270

(51) Int. Cl. A23B 9/06; A01C 1/06

(52) U.S. Cl. CPC A23B 9/06; A01C 1/06

(57) ABSTRACT

The present invention relates to improvements in irradiation of grain or seeds, including (but not necessarily solely) grains or seeds for ingestion by animals. More particularly, the invention relates to an apparatus for, methods of irradiating grain or seeds, and the modified grain or seeds which have been produced by the methods and apparatus described herein.

### FIELD

The present invention relates to improvements in irradiation of grain or seeds, including (but not necessarily solely) grains or seeds for ingestion by animals. More particularly, the invention relates to an apparatus for, methods of irradiating grain or seeds, and the modified grain or seeds which have been produced by the methods and apparatus described herein.

### BACKGROUND

Grains and seeds, individually or in bulk amounts, can incorporate constituents, such as (for example) pathogens and/or weeds or precursors thereto, which may give rise to undesirable replication or germination of the grains or seeds and/or contaminant weeds or pathogens. If grains are used as a substrate for a bait, such as to control mice over wide areas of farmland, the potential to spread of weeds or pathogens (e.g. leading to the production of wild radish or serrated tussock or rust fungus) coupled undermine or nullify the value of the mouse control Where the grains or seeds are distributed over an area of ground (particularly fertile ground), especially in the case of bait for animals it is preferable to inactivate the grain itself to prevent germination in order to not contaminate a crop such as rape or canola or barley with the wheat plants developed from the bait material.

There is an ongoing need in the art for effective means of eliminating and/or deactivating such constituents. Irradiation of the grain is an effective method, however high penetration radiation that penetrates through the grain or seed in one pass, such as gamma irradiation, is slow and low volume. Low penetration, lower cost irradiation, more suited to thin films, will not penetrate through large thicknesses of mass grain or seed and requires the seed or grain unless very high acceleration energies are used or unless the grain is passed via a beam multiple times.

There is an ongoing need in the art for effective means which is single pass, high speed and high volume, but using low cost radiation beams.

### SUMMARY OF INVENTION

According to a first aspect of the present invention, there is provided an apparatus for irradiating grain or seed, comprising:
at least one agitator, operable to induce rotation of particles of said grain or seed; and
at least one irradiator, arranged to emit radiation such that said particles are irradiated thereby.

According to a second aspect of the present invention, there is provided a method of irradiating grain or seed, comprising:
agitating particles of said grain or seed to induce rotation thereof; and
emitting radiation such that said rotating particles are irradiated thereby,
such as by operating the agitator(s) and irradiator(s), respectively, of a said apparatus.

In an embodiment and with reference to the above embodiment, the emitting radiation of said rotating particles is from multiple perspectives/angles.

In preferred embodiments of the invention, said radiation is effective to eliminate and/or deactivate, preferably genetically, constituents (of said grains or seeds) as discussed above.

In a preferred embodiment of the invention, the irradiated particles may be for distribution over an area of ground, especially fertile ground.

In a preferred embodiment of the invention, the irradiated particles may be treated with a chemical or other substance before distribution over an area of ground, especially fertile ground.

According to a third aspect of the present invention, there is provided grain or seed comprising particles irradiated by the apparatus of the first aspect or method of the second aspect.

### DESCRIPTION OF INVENTION

In the context of seeds, the invention has particular, though not exclusive, application in respect of bird seeds and/or imported seeds. In the context of grain, the invention has particular, though not exclusive, application in respect of wheat, barley, or lupins or similar.

In the preferred embodiments of the invention, the rotation is such that particles of the grain or seed are irradiated throughout over the entireties of their surface areas or external surfaces. In preferred embodiments of the invention, the radiation comprises radiation which is of relatively low penetration through the particles, but sufficiently penetrating to achieve dosing to the endosperm of the grains as compared to gamma radiation, which is relatively high-penetration—and can, for instance, penetrate through about one metre of grain such as wheat.

The irradiation level may be any amount in excess of 5 kGray and will vary depending on the constituents to be rendered inactive. Preferably, the irradiation is such that a dosage of said radiation to said particles is around, or in excess of, 7 kGray, such as about 10 kGray, 12 kGray, 14 kGray, 15 kGray 17 kGray, 20 KGray, 25 KGray, 27 kGray, 30 kGray, 35 kGray, 40 kGray, 45 kGray, 50 kGray, 55 kGray, 60 kGray, 65 kGray, or about 70 kGray, or above, or any range between any two of the above radiation doses.

The radiation may comprise, for example, x-ray radiation and/or electron radiation, the latter preferably comprising high-level electron radiation.

Preferably, the method comprises operating said agitator(s) and irradiator(s) of said apparatus to induce rotation of said particles and to emit said radiation such that said rotating particles are irradiated thereby, respectively.

The agitator may comprise, for example, any of mechanical, static and pneumatic agitators.

The agitator my comprise, for example, a pneumatic agitator operable to generate a bed of gas, such as air, which effects or contributes to said rotation.

In a preferred embodiment of the invention, at least one said static agitator comprises a baffle structure.

In a preferred embodiment of the invention, at least one said mechanical agitator comprises vibratory and/or oscillatory agitator.

In a preferred embodiment of the invention, at least one said mechanical agitator comprises a rotational agitator, such as a rotatable drum or tube. The radiation may be emitted, or the irradiator arranged to emit radiation, from a position radially inward of a circumferential wall of said drum or tube arranged to support the particles, whereby the radiation is incident upon the particles supported by said wall.

Preferably said apparatus includes at least one input, arranged so as to be upstream of the agitation means, via which the grain or seed is receivable by the apparatus.

Preferably said apparatus includes at least one output, arranged so as to be downstream of the agitation means, via which irradiated grain or seed can be output by the apparatus.

Preferably, said apparatus is operable to effect travel of the grain or seed particles past the irradiation means such that said particles are irradiated.

Preferably, said apparatus is configured to define at least one pathway and operable to flow or carry said particles therealong. At least one said pathway may comprise one or more conduits.

Said conduit(s) may be convoluted, twisted or curved so as to allow no straight line pathway for the escape of radiation from the apparatus.

The apparatus according to a preferred embodiment of the invention comprises a conveyor defining at least one said pathway.

According to a fourth aspect of the present invention, there is provided a method of producing a seed- or grain-based preparation or animal bait, comprising:
irradiating grain or seed particles by means of the apparatus of the first aspect or method of the second aspect and applying at least one additive to the particles; or
applying at least one additive to irradiated grain or seed particles of the third aspect.

Preferably, the at least one additive is applied to the particles after irradiation thereof.

According to a fifth aspect of the present invention, there is provided a preparation or animal bait produced by the method of the fourth aspect.

Preferably, the bait or additive(s) comprise/s a rodenticide, and as such is a toxic animal bait.

A preferred embodiment of the invention provides animal bait comprising a rodenticide which is coated on the surface of the irradiated grain or seed particles. Preferably, the toxic bait is for mice or rats.

In a preferred embodiment of the method of the fourth aspect or bait of the fifth aspect, the rodenticide is selected from any one or more of:
zinc phosphide;
coumarin anticoagulant, which may comprise either or each of:
   at least one first-generation anticoagulant, such as either or both of warfarin and coumatetralyl; and
   at least one second-generation anticoagulant, such as any one or more of brodifacoum, bromadiolone and flocoumafen; and
an indole anticoagulant, such as either or both of pindone and diphacinone.

While as described above one form of the methods described herein is to pre-sterilise grain prior to other processes, the invention also contemplates methods which involve completing the sterilisation after mixing of grain with other materials.

Preferred embodiments of the invention will now be described, by way only of non-limiting example, with reference to the accompanying drawings, in which:

FIG. 1 is a schematic view of an apparatus for irradiating grain or seed in accordance with a first embodiment of the present invention;

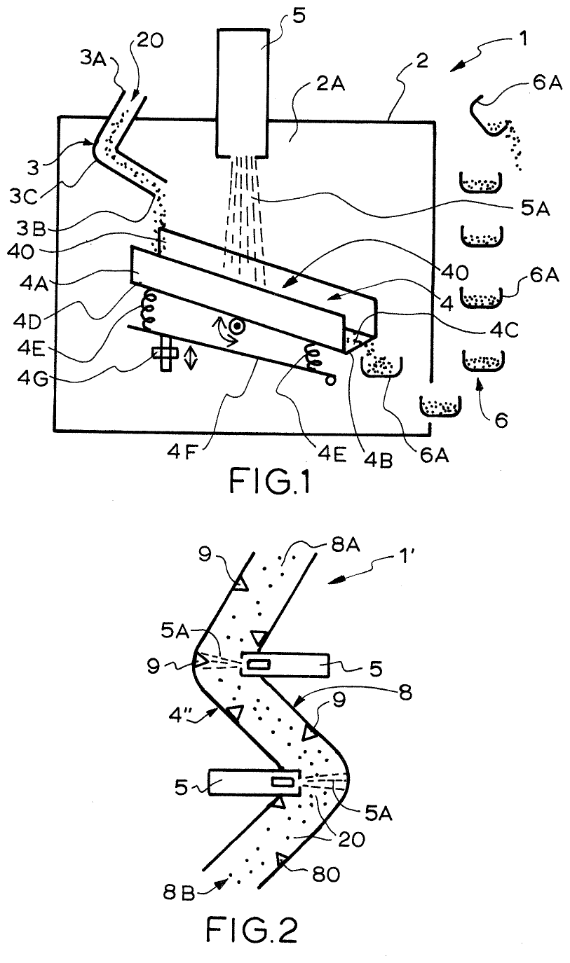

FIG. 2 is a schematic view of an apparatus for irradiating grain or seed in accordance with a second embodiment of the present invention;

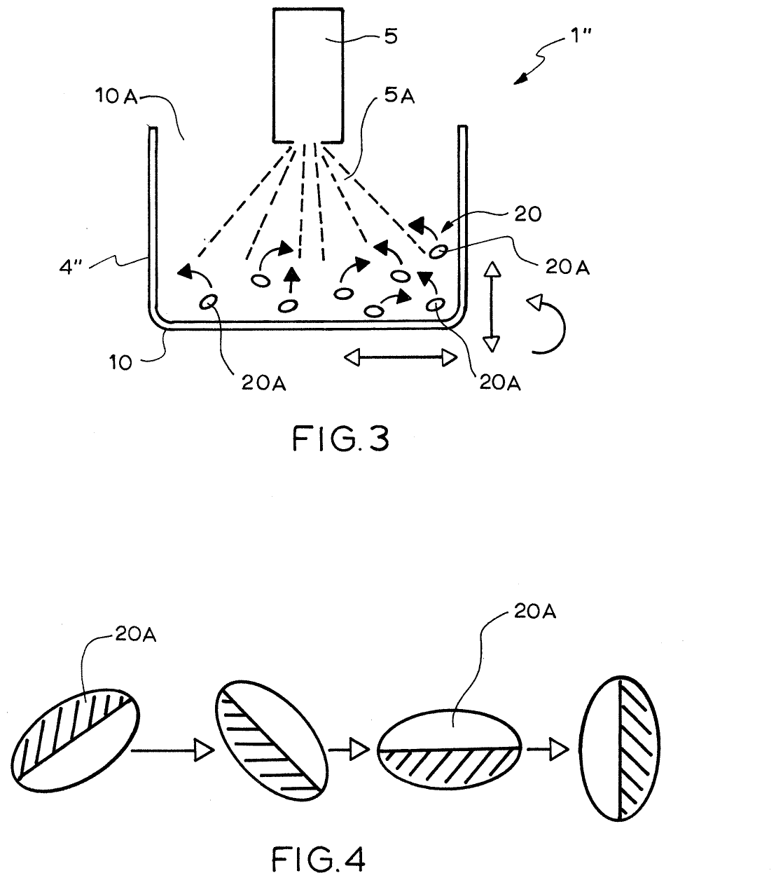

FIG. 3 is a schematic view of an apparatus for irradiating grain or seed in accordance with a third embodiment of the present invention;

FIG. 4 is a schematic view showing tumbling of a grain or seed (“particle”) induced by the apparatus of any of the embodiments of the invention described herein with reference to the (other drawings);

FIG. 5 is a schematic view of an apparatus for irradiating grain or seed with radiation applied at right angles to the direction of travel; and

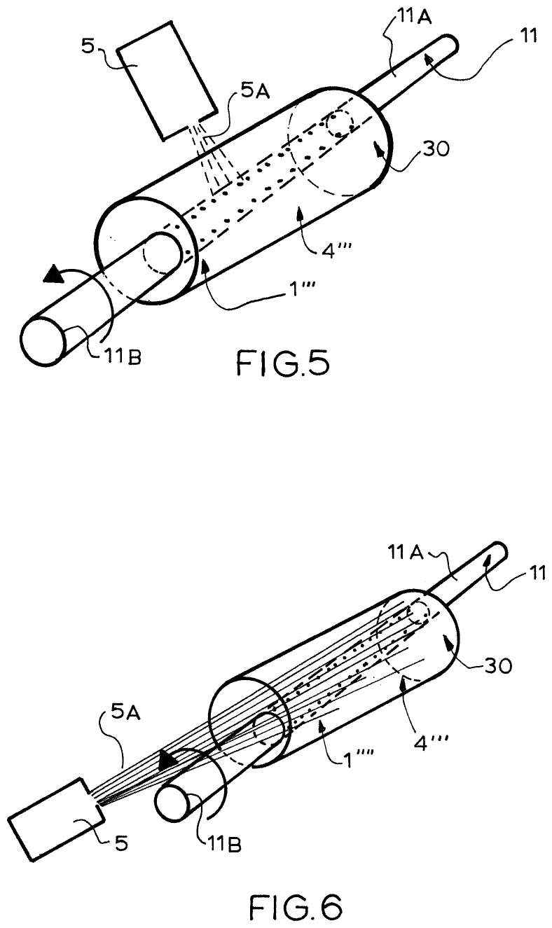

FIG. 6 is a schematic view of an apparatus for irradiating grain or seed with radiation applied along the direction of travel.

Shown in FIG. 1 is an apparatus 1 for irradiating grain or seed 20 according to a first embodiment of the present invention, the apparatus 1 comprising a radiation shielding structure 2, which comprises radiation-absorbing material and encloses a space 2A, a conduit or chute 3 having an upstream end 3A at a location exterior of the structure 2/apparatus 1, through which end the grain or seed 20 is receivable by the chute 3, that end thus defining an input via which the grain or seed 20 can be supplied to the apparatus 1, and a downstream end 3B arranged within the space 2A.

The apparatus 1 further comprises a mechanical agitator 4, arranged in the space 2A adjacent a downstream end 3B of the chute 3 to receive, at an upstream end 4A thereof, grain or seed 20 flowing from the end 3B, the agitator 4 being vibrateable to agitate the grain or seed 20, thereby causing particles 20A thereof (comprising grain particles or seeds, respectively) to tumble, as shown in FIG. 4, and being configured and arranged (as described further below) to permit or effect displacement or continued flow of the grain or seed 20 therealong, and an irradiator 5 operable to emit a beam 5A of radiation—comprising electrons and/or other radiation, such as, for example, x-ray radiation—into the space 2A and towards the agitator 4 whereby the radiation is incident upon the grain or seed particles 20A. The radiation may, alternatively or additionally, comprise radiation resulting from decay of an isotope, such as cobalt-60 (Co⁶⁰) gamma irradiation.

Thanks to rotation induced in the particles 20A by the tumbling action, much—and preferably all—of the surface areas thereof are presented to the beam 5A as the particles pass through it, absorption of the radiation by the particles 20A thus being promoted.

The apparatus 1 additionally comprises a bucket conveyor 6 comprising a plurality of receptacles or buckets 6A and operable such that successive ones of the buckets 6A move into the path of irradiated particles/grain or seed 2 output from a downstream end 4B of the agitator 4, thus collecting the irradiated particles/grain or seed 2 within the space 2A, and carry the particles/grain or seed 2 collected thereby to a location exterior of the structure 2/apparatus 1, the conveyor 6 being further operable to empty the particles/grain or seed 2 from the buckets 6A (e.g. by tipping each receptacle 6A as shown, or instead by effecting opening of clam shell portions which define the receptacle) into a collection receptacle, such as a hopper (not shown). The bucket conveyor 6 thus defines an output of the apparatus 1.

The chute 3, which may also be comprised of radiation-absorptive material, comprises an elbow 3C or is otherwise non-linear so as not to provide a direct path for escape therethrough of radiation emitted into the space 2A.

The agitator 4 in the present embodiment comprises grain or seed holder and carrier 40, comprising a channel, having a base or floor 4C to support the grain or seed from beneath and opposed side walls 4D to contain the grain or seed therebetween. The agitator 4 further comprises one or more springs 4E, to upper/first ends of which the channel or base 4C is connected, a support 4F, to which second/lower ends of the springs 4E are connected (whereby the channel is supported from the support 4F via the springs 4E), and a mechanical exciter 4G (e.g. comprising a rotatable eccentric mass) operable to exert intermittent forces on the support 4F and thus induce, via the springs 4E, vibration or oscillation of the channel, effecting the agitation of the grain or seed 20. It is possible that the connection between the support 4F and the holder/carrier 40 can be other than via springs 4E; it could, for example, be a direct connection, and/or be constructed of and/or comprise, another material comprising, for example, flexible rubber and/or laminated plastic and/or fibreglass and/or carbon fibre.

The channel 40 may be downwardly inclined, such that displacement or flow of the grain or seed therealong is effected or assisted by gravity. Alternatively or additionally, the agitator 4 may be configured such that the carrier 40 when displaced upwardly, in each oscillatory or vibratory cycle thereof, is additionally displaced forwardly (in a downstream direction) so as to impart forward motion to the grain or seed whereby the latter is conveyed to the end 4C.

The agitation/vibration rate of the agitator 4, and/or the slope or inclination, of the channel or carrier 40 may be adjustable.

The holder/carrier 40 may include formations or protuberances (not shown) arranged on the inner side of the base/floor 4C and/or side walls 4D so as to lie in and/or define the path of the particles/grain or seed 20 travelling therealong, whereby the particles 20A are incident upon the formations or protuberances and are thereby caused to tumble or rotate. Said formations or protuberances may comprise, for example, ribs and/or ridges and/or ledges and/or corrugations, which may comprise ones that extend parallel one-to-another and/or to an axis such as (for example) the longitudinal axis of the channel, and/or ones that extend perpendicular to that axis and/or ones that extend oblique to that axis. Said formations or protuberances may, alternatively or additionally, comprise nodules and/or bumps. Said formations or protuberances may, alternatively or additionally, comprise recesses, such as dimples and/or channels and/or craters and/or concavities.

In the present embodiment, the agitator 4 thus defines a conveyor, chute or conduit to carry the irradiated particles/grain or seed 2 to the output.

Shown in FIG. 2 is an apparatus 1′ for irradiating grain or seed 20 according to a second embodiment of the present invention. The apparatus 1′ comprises a static agitator 4′, which comprises a chute 8 for the grain or seed 20, and one or more irradiators 5 arranged and operable to emit radiation beam(s) 5A into the interior of the chute 8 whereby the radiation is incident upon the grain or seed particles 20A.

The chute 8, comprises a conduit 80, having an upstream end 8A through which the grain or seed 20 is receivable by the chute 8, that end thus defining an input via which the grain or seed 20 can be supplied to the apparatus 1′, and a downstream end 8B through which irradiated particles/grain or seed 2 are output from the chute 8/apparatus 1′ for receipt by a collection receptacle, such as a hopper (not shown), the end 8B thus defining an output of the apparatus 1′. The conduit 80, which may also be comprised of radiation-absorptive material, comprises one or more elbows or bends (thereby assuming a zigzag configuration as shown) or is otherwise non-linear so as not to provide a direct path for escape therethrough of the radiation emitted into the conduit 80.

The chute 8 further comprises protuberances 9 which project from a wall of the conduit 80 into the conduit interior so as to lie in the path of the particles/grain or seed 20 travelling, under the influence of gravity, through the chute 8/conduit 80, whereby particles of the grain or seed 20 impact the protuberances 9 and are caused to tumble.

Thanks to rotation induced in the particles 20A by the baffle structure defined by the static agitator 4′, much of the surface areas thereof are presented to the beams 5A as the particles 20A pass through them, absorption of the radiation by the particles 20A thus being promoted.

Shown in FIG. 3 is an apparatus 1″ for irradiating grain or seed 20 according to a third embodiment of the present invention. The apparatus 1″ comprises a mechanical agitator 4″, which comprises a grain or seed holder 10, defined by a receptacle into which the grain or seed 20 is input via an open top 10A thereof, at least one irradiator 5 arranged and operable to emit radiation beam(s) 5A into the interior of the holder 10 whereby the radiation is incident upon the grain or seed particles 20A therein.

The agitator 4″ is operable to vibrate or oscillate so as to induce tumbling/rotation of the particles 20A, whereby much of the surface areas thereof are presented to the beam 5A and absorption of the radiation by the particles 20A is promoted. The apparatus 1″ may, to that end, include an assembly comprising at least one exciter 4G as previously described arranged to impart mechanical disturbances to the holder 10, e.g. via one or more springs 4E as previously described.

In the present embodiment, the open top 10A defines an input of/into and output of/from the agitator 4″/apparatus 1″. The apparatus 1″ may include a radiation shielding structure 2, enclosing a space 2A, in which case the agitator 4″ and (at least) the emitter of the/each irradiator 5 is contained in the space 2A, and the structure 2 is configured—e.g., is openable—such that the interior thereof/space 2A can be accessed whereby the grain or seed 20 can be supplied to the holder 10, and once irradiated removed from the holder 10, through the open top 10A.

Shown in FIG. 5 is an apparatus 1′″ for irradiating grain or seed 20 according to a fourth embodiment of the present invention. The apparatus 1′″ comprises a mechanical agitator 4′″, which comprises a grain or seed holder in the form of a tubular or cylindrical drum 30, and a rotatable shaft 11, comprising separate upstream 11A and downstream 11B shaft sections, to which the drum or tube 30 is connected. The shaft 11 is rotatable about its central axis, by a powered rotational driver of the apparatus 1′″ (not shown) to which it is coupled, and is arranged such that that axis is offset—translationally and/or rotationally—from a central axis of the drum or tube 30.

The apparatus 1′″ further comprises at least one irradiator 5 arranged and operable to emit the beam of radiation 5A into the interior of the drum or tube 30. In the example illustrated, the/each irradiator is arranged outside the drum or tube 30 and the side wall structure of the drum or tube 30 is permeable such that the radiation can pass therethrough to irradiate the grain or seed particles 20A therein.

Rotation of the shaft 11 causes the drum or tube 30 to rotate eccentrically, whereby the grain or seed particles 20A tumble therein, the resulting rotation of the particles 20A causing much of the surface areas thereof to be presented to the beams 5A, such that absorption of the radiation by the particles 20A is promoted.

The drum or tube 30, particularly the wall structure thereof, may be configured with one or more openings, and/or openable, such that there are defined one or more openings, for supply of the grain or seed 20 therethrough to the drum or tube 30 for irradiation and for removal, exit or egress of the irradiated grain or seed 20 therethrough from the drum or tube 30. For example, the upstream shaft section 11A is tubular and forms a conduit through which the grain or seed 20 can be fed to the drum or tube 30 and the downstream shaft section 11B is likewise tubular and forms a conduit through which the irradiated grain or seed 20 can flow from the drum or tube 30 for collection (e.g. in a hopper as previously mentioned).

The apparatus 1′″ may include a radiation shielding structure 2, enclosing a space 2A, in which case the agitator 4′″ and (at least) the emitter of the/each irradiator 5 is contained in the space 2A, and the structure 2 is configured—e.g., is openable—such that the interior thereof/space 2A can be accessed whereby the grain or seed 20 can be supplied to the drum or tube 30, and once irradiated removed from the holder 10, through the open top 10A.

The drum or tube 30 may comprise formations or protuberances (not shown) arranged on the inner side of the circumferential/side wall which can, as the drum or tube 30 rotates, be positioned to lie in and/or define the path of the particles/grain or seed 20 travelling through the drum or tube 30, whereby the particles 20A strike or are incident upon the formations or protuberances and are thereby caused to tumble or rotate. Said formations or protuberances may comprise, for example, ribs and/or ridges and/or ledges and/or corrugations, which may comprise ones that extend parallel one-to another and/or to an axis such as (for example) the rotational or drum or tube axis, and/or ones that extend circumferentially around the wall and/or ones that extend perpendicular to the rotational or drum or tube axis. Said formations or protuberances may, alternatively or additionally, comprise nodules and/or bumps. Said formations or protuberances may, alternatively or additionally, comprise recesses, such as dimples and/or channels and/or craters and/or concavities.

The drum or tube 30 is downwardly inclined, such that displacement or flow of the grain or seed 20 therealong is effected or assisted by gravity. The rotation rate, and/or the slope or inclination, of the drum or tube 30 may be adjustable.

Rotation of the shaft 11 causes the drum or tube 30 to rotate eccentrically, whereby the grain or seed particles 20A tumble therein, the resulting rotation of the particles 20A causing much/all of the surface areas thereof to be presented to the beams 5A, such that absorption of the radiation by the particles 20A is promoted.

The particles 20A may tumble/rotate may rotate several times as they travel through the drum or tube 30. The irradiator 5 is preferably arranged such that the beam(s) emitted therefrom is/are incident upon the grain 20 along the entirety of the pathway along which it travels in the drum or tube 30. Particles 20A in the region of the upstream end of the drum or tube 30 may comprise ones that are (initially) shielded by the others from the radiation, though may spread out and/or be otherwise redistributed, and/or may be/become airborne within the drum or tube 30, as they travel along the pathway, whereby particles 20A, including the aforementioned initially shielded ones, are exposed to the radiation.

The drum or tube 30, particularly the wall structure thereof, may be configured with one or more openings, and/or openable such that there are defined one or more openings, for supply of the grain or seed 20 therethrough to the drum or tube 30 for irradiation and for removal therethrough of the irradiated grain or seed 20 from the drum or tube 30. For example, the upstream shaft section 11A is tubular and forms a conduit through which the grain or seed 20 can be fed to the drum or tube 30 and the downstream shaft section 11B is likewise tubular and forms a conduit through which the irradiated grain or seed 20 can flow from the drum or tube 30 for collection (e.g. in a hopper as previously mentioned).

Shown in FIG. 6 is an apparatus 1′″ for irradiating grain or seed 20 according to a fifth embodiment of the present invention. The apparatus 1′″ is the same as apparatus 1′″ except that external irradiator 5 thereof, instead of being arranged facing and adjacent to a suitably radiation-permeable side wall of the drum or tube 30 (whereby the radiation it emits projects or passes through that wall, and into/within/through the drum or tube 30, transverse to the drum or tube or rotational axis), is arranged facing and adjacent to a suitably radiation-permeable wall at an output end of the drum or tube 30, whereby the radiation it emits whereby the radiation it emits projects or passes through that wall, and into/within/through the drum or tube 30, generally longitudinally or lengthways.

Without departure from the invention, in a variant of the apparatus 1′″ or 1′″, the output end of the drum 30 may be configured with at least one opening through which radiation from a said irradiator (e.g. that from the irradiator 5 in apparatus 1′″) passes into the drum or tube 30 and/or for removal, exit or egress (from the drum or tube 30) of the irradiated grain or seed 20 therethrough; the end wall, for instance, may be omitted, whereby the end, or circumferential edge, of the circumferential or side wall of the drum or tube 30 delineates such an opening—in which case the shaft 11B could be connected directly—e.g. welded—to that end or edge. Alternatively or additionally, the variant may have a plurality of irradiators—e.g. comprising both of irradiators 5 shown in FIGS. 5 and 6—and/or have at least one irradiator which, or the emitter of which, is positioned within the drum or tube 30).

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. (canceled)

2. A method of irradiating grain or seed, comprising:
agitating particles of said grain or seed to induce rotation thereof; and
emitting radiation such that said rotating particles are irradiated thereby, said method comprising operating the agitator(s) and irradiator(s), respectively, of an apparatus, comprising:
at least one agitator, operable to induce rotation of particles of said grain or seed; and
at least one irradiator, arranged to emit radiation such that said particles are irradiated thereby.

3. The method according to claim 2, said radiation being effective to eliminate and/or deactivate constituents of said particles.

4. The method according to claim 2, the irradiated particles being for distribution over an area of ground.

5. The method according to claim 2, the (irradiated) particles being for baiting animals.

6. The method according to claim 2, said particles comprising particles of seed.

7. (canceled)

8. (canceled)

9. The method according to claim 2, said particles comprising particles of grain.

10. (canceled)

11. The method according to claim 2, the rotation being such that particles are irradiated throughout and/or over the entireties of their surface areas or external surfaces.

12. The method according to claim 2, the radiation comprising radiation which is of relatively low penetration through the particles, or
the radiation comprising radiation which is of relatively low penetration through the particles as compared to gamma radiation or,
the irradiation being such that a dosage of said radiation to said particles is around, or in excess of, 5 kGray, or the radiation comprising x-ray radiation, or
the radiation comprising radiation resulting from decay of an isotope, or
the radiation comprising electron radiation, or the electron radiation high-level electron radiation.

13. (canceled)

14. (canceled)

15. (canceled)

16. (canceled)

17. (canceled)

18. (canceled)

19. The method according to claim 2, the agitation being, or agitator(s) being operable, such that the particles are suspended and tumbled by a bed of air.

20. The method according to claim 2, comprising operating said agitator(s) and irradiator(s) of said apparatus to induce rotation of said particles and to emit said radiation such that said rotating particles are irradiated thereby, respectively.

21. The method according to claim 2, wherein the at least one agitator comprises at least one mechanical agitator and/or wherein the agitation comprises mechanical agitation, and wherein said at least one mechanical agitator comprises one or more vibratory and/or oscillatory agitators and/or wherein the mechanical agitation comprises vibratory and/or oscillatory agitation.

22. (canceled)

23. The method according to claim 21, wherein said at least one mechanical agitator comprises one or more rotational agitators and/or wherein the mechanical agitation comprises rotational agitation, or
wherein said at least one mechanical agitator comprises a drum or tube.

24. (canceled)

25. The method according to claim 23, wherein radiation is emitted, or at least one said irradiator is arranged to emit radiation, from a position radially inward of a circumferential wall of a said rotational agitator or drum or tube arranged to support the particles, whereby the radiation is incident upon the particles supported by said wall.

26. The method according to claim 21, wherein radiation is emitted, or at least one said irradiator is arranged to emit radiation, from a position radially outward of a circumferential wall of a said rotational agitator or drum or tube arranged to support the particles, whereby the radiation is incident upon the particles supported by said wall.

27. (canceled)

28. (canceled)

29. The method according to claim 2, wherein at least one said agitator comprises a baffle structure, or
wherein the agitator comprises at least one pneumatic agitator, or
wherein the at least one pneumatic agitator comprises one or more actuators operable to generate a bed of gas, which effects or contributes to said rotation.

30. (canceled)

31. (canceled)

32. The method according to claim 2, the apparatus including at least one input, which may be arranged to be upstream of the agitator(s), via which the grain or seed is receivable by the apparatus.

33. The method according to claim 2, the apparatus including at least one output, which may arranged to be downstream of the agitator(s), via which irradiated grain or seed can be output by the apparatus.

34. The method according to claim 2, the apparatus being operable to effect and/or configured to permit travel of the particles past the irradiator(s) means such that said particles are irradiated, or wherein the particles travel past the irradiator(s) means such that said particles are irradiated.

35. The method according to any claim 2, the apparatus defining, or wherein there is defined, at least one pathway and operable to flow or carry said particles therealong.

36. (canceled)

37. (canceled)

38. (canceled)

39. (canceled)

40. (canceled)

41. The method according to claim 2, wherein a radiation shielding structure is arranged to contain radiation to the apparatus, or comprising a radiation shielding structure in which the at least one agitator and/or at least one irradiator or emitter(s) thereof is/are arranged.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. Grain or seed comprising particles irradiated by the method according to claim 2.
